(19) United States
(12) Patent Application Publication
(10) Pub. No.: US 2023/0031512 A1
(43) Pub. Date: Feb. 2, 2023

(54) SURROGATE HIERARCHICAL MACHINE-LEARNING MODEL TO PROVIDE CONCEPT EXPLANATIONS FOR A MACHINE-LEARNING CLASSIFIER

(71) Applicant: Feedzai - Consultadoria e Inovação Tecnológica, S.A., Coimbra (PT)

(72) Inventors: João Pedro Bento Sousa, Leiria (PT); Vladimir Balayan, Lisbon (PT); Ricardo Miguel de Oliveira Moreira, Lisbon (PT); Pedro dos Santos Saleiro, Lisbon (PT); Pedro Gustavo Santos Rodrigues Bizarro, Lisbon (PT)

(21) Appl. No.: 17/867,311

(22) Filed: Jul. 18, 2022

Related U.S. Application Data
(63) Continuation-in-part of application No. 17/461,198, filed on Aug. 30, 2021, now Pat. No. 11,392,954.
(60) Provisional application No. 63/282,306, filed on Nov. 23, 2021.
(60) Provisional application No. 63/091,807, filed on Oct. 14, 2020.
(60) Provisional application No. 63/154,557, filed on Feb. 26, 2021.

(30) Foreign Application Priority Data
Aug. 26, 2021 (EP) 21193396.5
Aug. 26, 2021 (PT) 117427
Jun. 23, 2022 (EP) 22180841.3

(51) Int. Cl. G06N 20/00

(52) U.S. Cl. CPC G06N 20/00

(57) ABSTRACT

In various embodiments, a process for providing a surrogate hierarchical multi-task machine learning model (“model”) includes configuring the model to perform (i) a knowledge distillation task associated with a pre-trained classifier (“black-box model”) and (ii) an explanation task to predict semantic concepts for explainability associated with the distillation task. The model includes a concept layer to perform the explanation task and a decision layer to perform the distillation task. The output of the concept layer is utilized as an input to the decision layer. The process includes receiving training data including input records and concept labels, and training the model by minimizing a joint loss function that combines a loss function associated with the distillation task and one associated with the explanation task. The loss function associated with the distillation task is determined by comparing an output of the decision layer and an output of the black-box model.

### CROSS REFERENCE TO OTHER APPLICATIONS

This application claims priority to U.S. Provisional Patent Application No. 63/282,306 entitled EXPLAINING BLACK-BOX MODELS THROUGH CONCEPT-BASED KNOWLEDGE DISTILLATION filed Nov. 23, 2021 which is incorporated herein by reference for all purposes.

This application claims priority to European Patent Application No. 22180841.3 entitled METHOD AND SYSTEM FOR OBTAINING A SURROGATE HIERARCHICAL MACHINE-LEARNING MODEL TO PROVIDE CONCEPT EXPLANATIONS FOR A MACHINE-LEARNING CLASSIFIER filed Jun. 23, 2022 which is incorporated herein by reference for all purposes.

This application is a continuation in part of U.S. patent application Ser. No. 17/461,198 entitled HIERARCHICAL MACHINE LEARNING MODEL FOR PERFORMING A DECISION TASK AND AN EXPLANATION TASK filed Aug. 30, 2021, which claims priority to U.S. Provisional Patent Application No. 63/091,807 entitled TEACHING THE MACHINE TO EXPLAIN ITSELF USING DOMAIN KNOWLEDGE filed Oct. 14, 2020, and claims priority to U.S. Provisional Patent Application No. 63/154,557 entitled WEAKLY SUPERVISED MULTI-TASK LEARNING FOR CONCEPT-BASED EXPLAINABILITY filed Feb. 26, 2021, and claims priority to Portugal Provisional Patent Application No. 117427 entitled A HIERARCHICAL MACHINE LEARNING MODEL FOR PERFORMING A DECISION TASK AND AN EXPLANATION TASK filed Aug. 26, 2021, and claims priority to European Patent Application No. 21193396.5 entitled A HIERARCHICAL MACHINE LEARNING MODEL FOR PERFORMING A DECISION TASK AND AN EXPLANATION TASK filed Aug. 26, 2021 each of which is incorporated herein by reference for all purposes.

### BACKGROUND OF THE INVENTION

With the adoption of more complex Machine Learning (ML) models, decision systems have become more opaque and less interpretable. In sensitive contexts, such as Financial Crime or Healthcare, humans-in-the-loop would benefit from easy to interpret explanations for the models' predictions, improving trust and efficiency of the decision-making process.

### BRIEF DESCRIPTION OF THE DRAWINGS

Various embodiments of the invention are disclosed in the following detailed description and the accompanying drawings.

FIG. 1 shows an example of concept-based explainability paradigm for machine learning models in tabular domain, applied to financial crime, and healthcare use-cases.

FIG. 2 shows a surrogate hierarchical machine learning model according to an embodiment.

FIG. 3 shows a hierarchical multi-task machine learning model according to an embodiment.

FIG. 4 shows a hierarchical multi-task machine learning model with an attention layer according to an embodiment.

FIG. 5 shows a hierarchical multi-task machine learning model with an attention input from a last shared layer according to an embodiment.

FIG. 6 shows a hierarchical multi-task machine learning model with an attention input from all concept embeddings according to an embodiment.

FIG. 7 shows a hierarchical multi-task machine learning model with an attention input from both the last shared layer and the concept embeddings according to an embodiment.

FIG. 8 shows a hierarchical multi-task machine learning model with an attention input from input records according to an embodiment.

FIG. 9 shows a hierarchical multi-task machine learning model with an attention layer and a classification ML model score as an input according to an embodiment.

FIG. 10 shows a schematic representation of an embodiment of a multi-task machine learning model in which a main task is predicted first and its decision is input to the explainability task according to an embodiment.

FIG. 11 shows an embodiment of neural network-specific surrogate explainer.

FIG. 12 is a flowchart illustrating an embodiment of a process for providing a surrogate hierarchical machine-learning model to provide concept explanations for a machine-learning classifier.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Concept-based explainability is a promising research direction that proposes the use of high-level domain explanations, e.g., patient symptoms for doctors, or fraudulent patterns for fraud analysts, such as “High speed ordering”, or “Suspicious Email”, instead of feature-attribution, e.g., models' input features, such as “mcc=7801”. However, commonly used explainability methods such as LIME or SHAP produce feature-attribution explanations that typically fail to fulfil human-in-the-loop explanation requirements. For example, generated explanations tend to be too technical and, therefore, too difficult to grasp by non-technical personas, e.g., fraud analysts.

Among the vast literature on Deep Learning (DL) interpretability, most methods produce explanations based on low-level features. While useful for ML experts, e.g., data scientists, these explanations remain predominantly unintelligible to most humans-in-the-loop, e.g., fraud analysts, which exhibit a high-level reasoning process. Recent work in concept-based explainability tries to bridge this information gap, producing more user-friendly concept-based explanations.

Earlier works on concept-based explainability, such as Testing with Concept Activation Vectors (TCAV) or Automated Concept-based Explanation (ACE) rely on post-hoc learning of concepts and subsequent assessment of their importance for the prediction of a given class. Both methods yield global concept explanations, i.e., the most relevant concepts for the prediction of a given class, instead of local explanations, i.e., the concepts that most contribute to a given instance prediction. Local concept explanations are typically better suited to help humans-in-the-loop decision-makers. Additionally, both methods are specific to images and neural network-based models.

TCAV creates representations of a given concept from sets of selected images with the presence of that human-understandable concept. Using these sets, TCAV learns to linearly discern the examples with and without the concept on the network's activation space. In this context, network's activation space refers to the output, or activation, of a layer 1 when provided an image as input.

ACE, on the other hand, adopts an unsupervised approach, discarding the need for additional labelled datasets. The method extracts concepts automatically by first generating local image segments over the data of a specific class. Then, ACE clusters these local segments in the network's activation space. Finally, each cluster is assigned an importance weight for the prediction of a given class.

Another branch of concept-based explainability targets in-model interpretability, or self-explainability. The most common approaches propose changes to both the architecture and the learning algorithm so that their model is able to learn both a predictive task and its explanations.

Some conventional techniques provide sequential self-explainable models to produce predictions and associated explanations. Despite focusing on different use cases, e.g., image and tabular, conventional methods cast the joint learning of the predictive and the concept-based explainability tasks as a multi-task learning approach. In particular, they propose to adapt standard neural-network models to accommodate a concept layer, whose outputs are the predicted explainability concepts, and an intermediary loss to ground the predictions of this layer to the concept labels. A strict hierarchy is enforced in the network so that the final classification predictions are linear functions of the predicted explainability concepts.

Another conventional technique provides a 3-layer prototype classifier network, requiring no concept labels. The first layer, named prototype layer, learns a set of prototype units by minimizing their distance to a lower dimensional latent representation of the input. A prototype unit is a prototype vector learnt by the model. To prevent degeneration of this latent representation, training is extended with a “prototype-to-input” decoder and a reconstruction loss. In the same vein, Self-Explainable Neural Network (SENN) is a model composed of two independent neural networks whose outputs are not only combined, e.g., linear combination, to form a prediction, but are also provided as explanations. One of the networks, dubbed concept encoder, is responsible for learning the representation of human-interpretable concepts from cues in input, whereas the other network learns to weight relevant concepts based on the input.

More recently, in the natural language domain, SelfExplain enriches text classification predictions with both global and local phrase-based concepts. Interpretability is added as an auxiliary task to the existing models. Thus, SelfExplain extends traditional models with two layers of different interpretability granularity, as well as appropriate terms to the training loss.

These conventional self-explainable approaches are framed as multi-task learning, consisting of a main classification task and an explainability task. Although promising conceptually, they typically attain sub-par performance in the main classification task due to known trade-offs in multi-task learning.

Another approach for explainability is knowledge distillation. This technique was firstly applied for model compression with a goal to approximate the functionality of the complex model by building a much simpler and faster model with similar performance. Data is passed through a complex model to obtain the scores probabilities that are used for training smaller models. An extension method introduces a “matching logits” method that uses the outputs produced by the model before the final activation function, usually used in Neural Network (NN) to normalize the scores between 0 and 1, instead of training with probabilities, which may improve the training of the smaller model.

In the Explainable Artificial Intelligence (XAI) field, knowledge distillation is used to improve the interpretability of complex ML models by using the black-box models' logits, and then use them for training a decision tree that is considered a transparent model. While the Knowledge distillation technique does not exhibit the limitations associated with the perturbation-based methods, e.g., LIME that perturb the input space by randomly changing some feature values, it still presents some problems. Firstly, its outputs are typically feature-based. This means that even though the model is simpler, it is still based on the same non-interpretable features of the more complex model and, therefore, explanations are still difficult to grasp and interpret by non-technical personas. Also, even after distilling the complex model, the resulting simpler model may have many parameters to reach approximately the same performance as the complex model.

Previous work has focused on providing concepts for specific model types, such as Neural Network models by trying to extract concepts from the learned network or through multi-task learning.

The present disclosure relates to a computer-implemented method for obtaining a surrogate hierarchical machine-learning model, trained to provide concept explanations for a machine-learning model classifier, for example a black-box model for which no explainability concepts are fully or partially known. This method uses a hierarchical surrogate neural network that learns to jointly mimic the machine-learning model and provides concept explanations. There are also disclosed several surrogate architectures and learning strategies.

In one aspect, concept-based explainability fills the gap of model interpretability for humans-in-the loop, i.e., domain experts that may lack deep technical knowledge in Machine Learning (ML).

FIG. 1 shows an example of concept-based explainability paradigm for machine learning models in tabular domain, applied to financial crime, and healthcare use-cases. 10 represents a health professional, 11 represents a fraud analyst, 12 represents an input, 13 represents an explained black-box, 14 represents a classification task, 15 represents a distillation loss, 16 represents a surrogate concept explainer, 17 represents a knowledge distillation task, and 18 represents an explainability task.

Here, the concept-based explainability techniques disclosed herein are deployed in real world applications, where human-in-the-loop without deep ML knowledge may avail high-level concept explanations that convey domain knowledge, enabling more valuable human-interpretable insights about complex models' predictions.

In an embodiment, a concept-based knowledge distillation explainer is configured to explain a machine learning model classifier, e.g., a black-box model, by distilling its knowledge into concept-based explanations. Said explainer, i.e., a surrogate model, is framed as a hierarchical multi-task (HMT) network, where a first task predicts concepts to serve as explanations, while a second task predicts the ML model classifier output given the concepts' predictions. The explainer receives as input a training set with concept annotations. The annotations may be obtained by a concept extractor with a manual annotation process or through any weak supervision technique, producing weak concept labels.

In an embodiment, D is framed as a binary classification task, y_{D}∈ [symbol] _{D}={0, 1} and a binary classification ML model [symbol] : [symbol] → [symbol] _{D}, where [symbol] (x)=ŷ_{D} the random variable (x; y_{D}) has an unknown joint distribution in X×Y_{D}, and ŷ_{D} is the classifier estimate of y_{D}. A goal is to explain C by distilling its knowledge into an explainer that aligns the predictions of the classification model while predicting the domain concepts which serve as explanations.

An explainer, f, is embodied by a multi-task hierarchical model having two individual tasks: a knowledge distillation task KD, where f learns to approximate the scores given by the ML model C; and a multi-label classification task, E, where f predicts k concepts to serve as explanations. Said explainer, f, is defined as f: [symbol] → [symbol] _{E}× [symbol] _{D D}, where f(x)=(ŷ_{E},ŷ_{K D}) is the (k+1)-dimensional output vector of k explanations plus the predicted knowledge distillation score. In this way, it is possible to maximize the model's performance at both tasks during training. Let [symbol] _{K D}(ŷ_{K D}, [symbol] (x)) and [symbol] _{E}(ŷ_{E}, y_{E}) represent the losses incurred by the model at the knowledge distillation and explainability tasks, respectively.

A surrogate explainer model f minimizes the weighted combination of both losses, as defined by [symbol] (ŷ, y)=λ [symbol] _{K D}(ŷ_{K D}, [symbol] (x))=(1−λ) [symbol] _{E}(ŷ_{E}, y_{E}). Given the inherent fidelity-explainability trade-off, in an embodiment, it is included a hyperparameter λ∈[0, 1] to weight the relative importance of the knowledge distillation task with respect to the concept-producing task, or explainability task. A high λ allows for high-fidelity between f and C at cost of the explainability task, while a low λ allows for high explainability task performance that might be decoupled from the model being explained.

Although this joint optimization/training of both tasks is the main training strategy in various embodiments, other strategies are disclosed. Depending on the nature of each task, different loss functions may be used. For example, [symbol] _{K D} is set as the Kullback-Leibler divergence loss (KLDiv) loss and [symbol] _{E} is set as the average binary cross entropy loss over the K concepts, i.e.,

$${ℒ}_{E} ( {\hat{y}}_{E} , {y}_{E} ) = \frac{1}{K} {\sum }_{i = 0}^{K} CE ( {\hat{y}}_{{E}_{i}} , {y}_{{E}_{i}} ) .$$

Note that although the aforementioned knowledge distillation loss 15 [symbol] _{K D} distils the explained model through its output score, it is possible to realize this distillation through the output's logit, if available. For example, it is possible to make the knowledge distillation process using both model's logits as follows. Let the explained model's output [symbol] (X)=ŷ_{P}=σ(z [symbol] ) and let the surrogate concept explainer 16 model's output f(x)=\dot{y}_{K D}=σ(ż); where σ represents the sigmoid activation function and z represents the respective model's logit. When performing the knowledge distillation task with the model's logits, the respective loss is redefined to [symbol] _{K D}(\hat{z}, z [symbol] ), where \hat{z}∈[−∞, +∞] and z [symbol] ∈[−∞, +∞]. When using logits for the knowledge distillation task, different loss functions can be used, for example, the KLDiv loss.

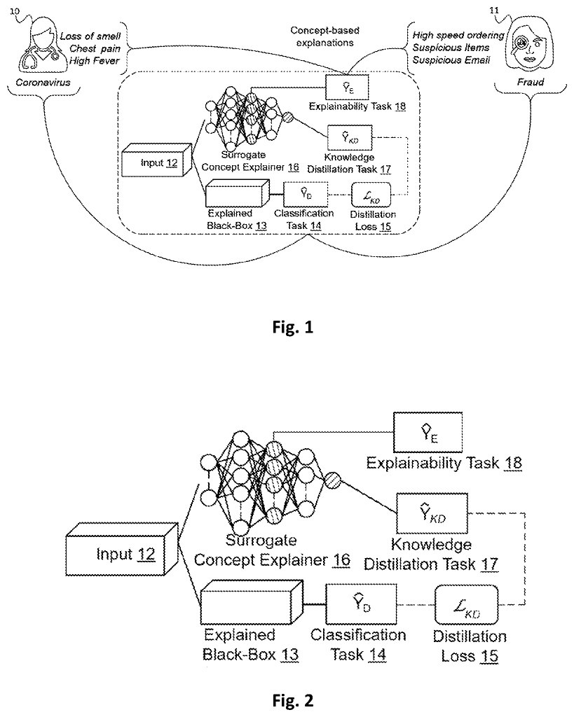

FIG. 2 shows a surrogate hierarchical machine learning model according to an embodiment. The surrogate hierarchical machine learning model is called the surrogate concept explainer 16 in this example. 12 represents an input, 13 represents an explained black-box, 14 represents a classification task, 15 represents a distillation loss, 17 represents a knowledge distillation task, and 18 represents an explainability task.

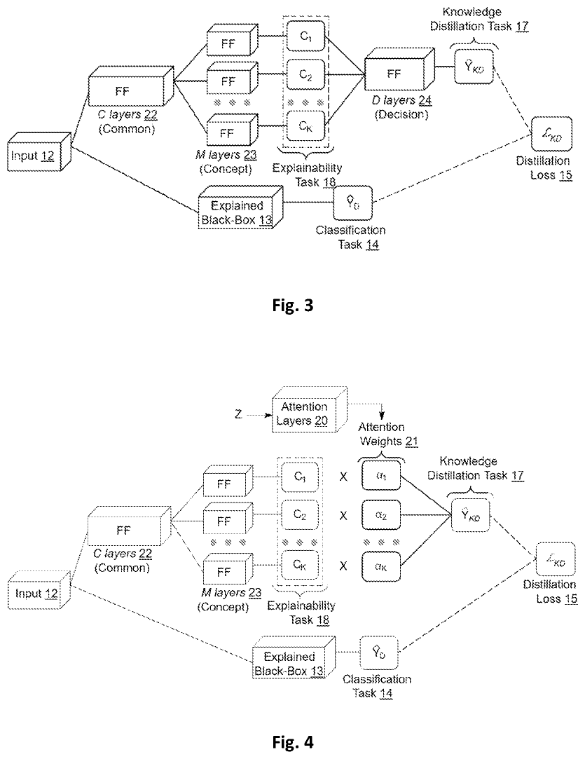

Various architectures for surrogate concept explainers 16 can be used, and FIGS. 3-10 show some examples of how to implement a surrogate concept explainer. The examples shown in FIGS. 3-10 receive an input and try to predict the machine learning model score, in this case a black-box model score, while trying to predict which domain concepts are present on the instance.

FIG. 3 shows a hierarchical multi-task machine learning model according to an embodiment. This figure shows an example of a surrogate concept explainer that includes C layers 22, M layer 23, and decision layers 24. Each of the components are like their counterparts in FIG. 2 unless otherwise described. In this embodiment, the explainer model f has a total of L layers where C of which, parameterized by θ_{C}, are common to all tasks, M of which, parameterized by {θ_{M}⁽ⁱ⁾}ᵢ₌₁^{K} represent concept-specialized layers, and D of which, parameterized by θ_{D}, are responsible for the knowledge distillation task. Here, 12 represents an input, 13 represents an explained black-box, 14 represents a classification task, 15 represents a distillation loss, 17 represents a knowledge distillation task, 18 represents an explainability task, 22 represents common layers, 23 represents concept layers, and 24 represents decision layers.

The output of the explainability task is ŷ_{E}=h(h(x; θ_{C}); θ_{M}^{(K)}, with the prediction of the i-th concept being ŷ_{E}=h(h|(x; θ_{C}); θ_{M}^{(K)}, where h(x; θ) represents the neurons' activation resulting from inputting x into a network parameterized by θ. The output of the knowledge distillation task is ŷ_{K D}=h(ŷ_{E};θ_{D}). Due to this hierarchical nature where the knowledge distillation task only has explainability-task predictions as input, a black-box's score is explained with concept predictions.

In an embodiment, if the feed-forward layers responsible for the knowledge distillation task have size one, meaning D=1, another explanation insight can be obtained using its weights θ_{D}.

These weights can serve as a global explanation for the knowledge distillation task, while their composition with the respective concept score can serve as local explanations ŷ_{E}⊙θ_{D}, where Θ represents the point-wise multiplication operator.

FIG. 4 shows a hierarchical multi-task machine learning model with an attention layer according to an embodiment. This figure shows an example of a surrogate concept explainer that includes C layers 22, M layer 23, and attention layers 20. Each of the components are like their counterparts in FIG. 2 unless otherwise described. 12 represents an input, 13 represents an explained black-box, 14 represents a classification task, 15 represents a distillation loss, 17 represents a knowledge distillation task, 18 represents an explainability task, 20 represents attention layers, 21 represents attention weights, 22 represents common layers, and 23 represents concept layers. This architecture, as also called AttentionHMT, is like the HMT with a 1-layer knowledge distillation component disclosed herein unless otherwise described. Unlike the HMT, in the AttentionHMT, the coefficients of each concept prediction are given by an attention.

In one aspect, this architecture allows for more flexibility and predictive power, thus replacing the linear knowledge distillation component for an attention mechanism.

In an embodiment, the AttentionHMT performs the explainability task in the same way as the HMT. The KD task output, however, is now defined as ŷ_{K D}=Σᵢ₌₀^{K} ŷ_{E}⁽ⁱ⁾×αᵢ, where y_{E}⁽ⁱ⁾ represents the prediction for the i-th concept, and αᵢ represents the i-th attention coefficient. In this architecture, no activation function is required to produce an output as it is needed to guarantee that ŷ_{K D}∈[0, 1] due to ŷ_{E}⁽ⁱ⁾∈[0, 1] and Σᵢ₌₀^{K} αᵢ=1.

In an embodiment, for the same architecture, the attention is given over the concept logits instead of the concept predictions. Consider y_{E}⁽ⁱ⁾=σ(\hat{z}ⁱ), where σ represents the sigmoid activation function and “zⁱ”∈[−∞, +∞] the i-th logit, the output of the network will then be ŷ_{K D}=σ(Σᵢ₌₀^{K} zⁱ×αᵢ). This approach allows for concepts to have an uncapped and negative impact on the score, as the logits are not constrained by the sigmoid to [0; 1].

In various embodiments, the attention coefficients are given by a Bandanau-styled attention layer, parameterized by θₐₜₜ and defined as:

αᵢ=softmax(eᵢ,e), (1)

e=AttentionBlock(Z), (2)

where Z represents the input to the Attention layer block 20 (also called AttentionBlock), which is a feedforward network with input Z and outputs attention weights 21 (K weights α).

In an embodiment, the AttentionBlock 20 can be a feedforward block of an arbitrary number of layers.

When considering the AttentionHMT architecture, different embodiments can be obtained by varying the information input to the attention layer block 20. Three examples, named as CommonAttentionHMT, SelfAttentionHMT, MixedAttentionHMT are shown in the following figures. Each of the systems have components like those of AttentionHMT unless otherwise described. As further described herein, the attention input Z differs in each example. Independent of the input, the attention layer outputs K weights corresponding to the K predicted concepts.

FIG. 5 shows a hierarchical multi-task machine learning model with an attention input from a last shared layer according to an embodiment. In this example, the attention input, Z, is from the last shared layer. This is referred to herein as CommonAttentionHMT. This figure shows an example of a surrogate concept explainer that includes C layers 22, M layer 23, and attention layers 20. Each of the components are like their counterparts in FIG. 2 unless otherwise described. 12 represents an input, 13 represents an explained black-box, 14 represents a classification task, 15 represents a distillation loss, 17 represents a knowledge distillation task, 18 represents an explainability task, 20 represents attention layers, 21 represents attention weights, 22 represents common layers, and 23 represents concept layers.

In an embodiment, the attention layer inputs the network embedding produced by the last shared layer, Z=h(x; θ_{C}), hereby defined as CommonAttentionHMT.

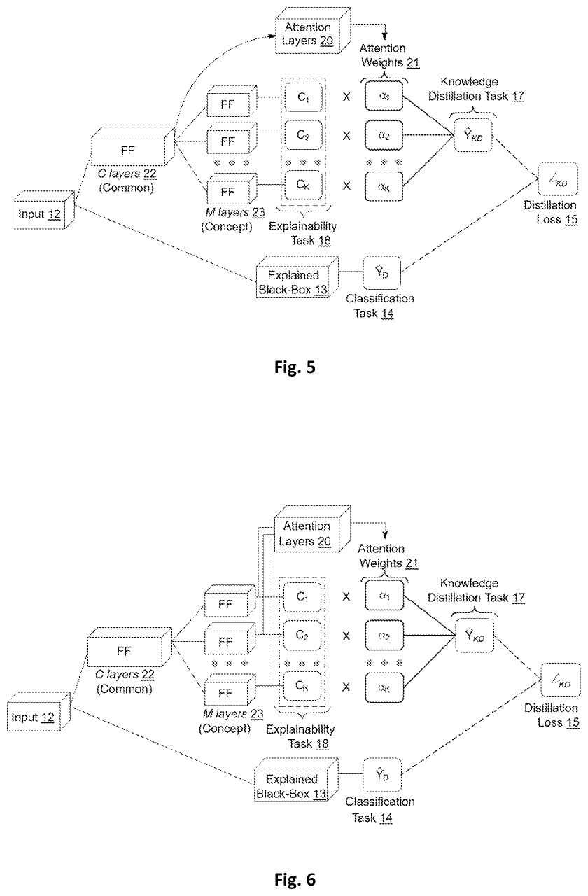

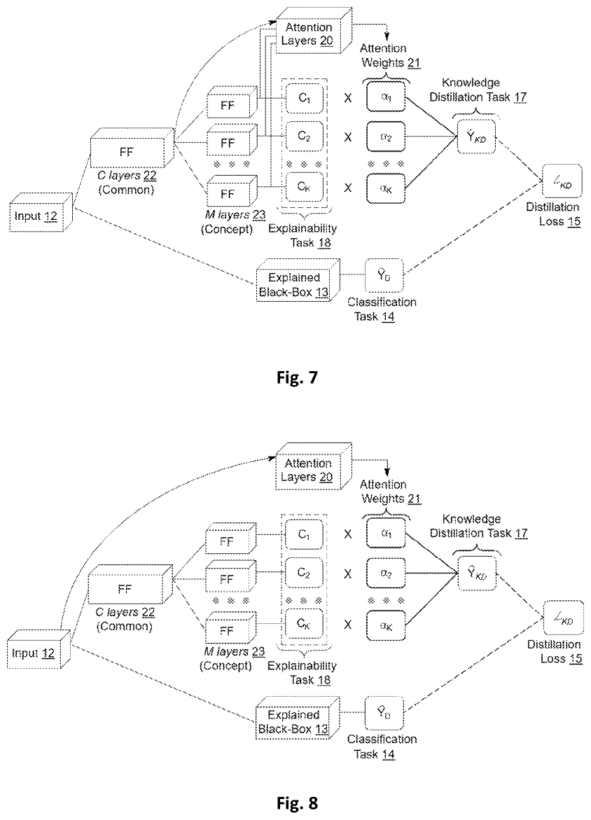

FIG. 6 shows a hierarchical multi-task machine learning model with an attention input from all concept embeddings according to an embodiment. In this example, the attention input, Z, is from all concept embeddings. This is referred to herein as SelfAttentionHMT. This figure shows an example of a surrogate concept explainer that includes C layers 22, M layer 23, and attention layers 20. Each of the components are like their counterparts in FIG. 2 unless otherwise described. 12 represents an input, 13 represents an explained black-box, 14 represents a classification task, 15 represents a distillation loss, 17 represents a knowledge distillation task, 18 represents an explainability task, 20 represents attention layers, 21 represents attention weights, 22 represents common layers, and 23 represents concept layers.

In an embodiment, the attention layer inputs the concatenation of all concept embeddings, Z=(emb₁; emb₂; . . . ; emb_{K}), where embᵢ=h(h(x; θ_{C}); θ_{M}⁽ⁱ⁾). In this architecture, a concept embedding embᵢ=h(h(x; θ_{C}); θ_{M}⁽ⁱ⁾) is the embedding of the i-th concept given by the M−1 concept specific layer, hereby defined as SelfAttentionHMT

FIG. 7 shows a hierarchical multi-task machine learning model with an attention input from both the last shared layer and the concept embeddings according to an embodiment. In this example, the attention input, Z, is from both the last shared layer and the concept embeddings. This is referred to herein as MixedAttentionHMT. This figure shows an example of a surrogate concept explainer that includes C layers 22, M layer 23, and attention layers 20. Each of the components are like their counterparts in FIG. 2 unless otherwise described. 12 represents an input, 13 represents an explained black-box, 14 represents a classification task, 15 represents a distillation loss, 17 represents a knowledge distillation task, 18 represents an explainability task, 20 represents attention layers, 21 represents attention weights, 22 represents common layers, and 23 represents concept layers.

In an embodiment, the attention layer inputs both the information defined on the CommonAttentionHMT and the SelfAttentionHMT embodiments. In this architecture Z is defined as Z=(h(x; θ_{C}); emb₁; emb₂; . . . ; emb_{K}).

In various embodiments, concept predictions, ŷ_{E} can be added to the embedding input of the attention layer. This addition allows the attention layer to have as input the vector that it will affect. For example, the input embedding for the CommonAttentionHMT architecture is defined as Z=(h(x; θ_{C}), ŷ_{E}), for the SelfAttentionHMT architecture as Z=(emb₁; emb₂; . . . ; emb_{K}; ŷ_{E}), and for the MixedAttentionHMT architecture as Z=(h(x; θ_{C}); emb₁; emb₂; . . . ; emb_{K}; ŷ_{E}).

In various embodiments, high-level concepts are encoded into an explainability layer, so the decision/knowledge distillation layer uses these concept predictions as inputs.

Through this encoding, explanation fidelity is guaranteed as well as feature importance's scores for the knowledge distillation task where the features are concept predictions.

FIG. 8 shows a hierarchical multi-task machine learning model with an attention input from input records according to an embodiment. This figure shows an example of a surrogate concept explainer that includes C layers 22, M layer 23, and attention layers 20. Each of the components are like their counterparts in FIG. 2 unless otherwise described. 12 represents an input, 13 represents an explained black-box, 14 represents a classification task, 15 represents a distillation loss, 17 represents a knowledge distillation task, 18 represents an explainability task, 20 represents attention layers, 21 represents attention weights, 22 represents common layers, and 23 represents concept layers.

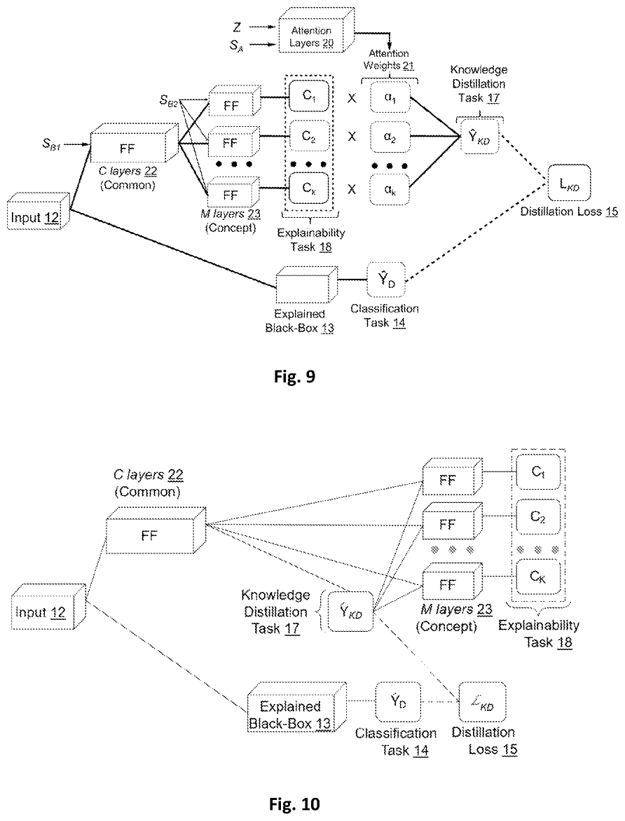

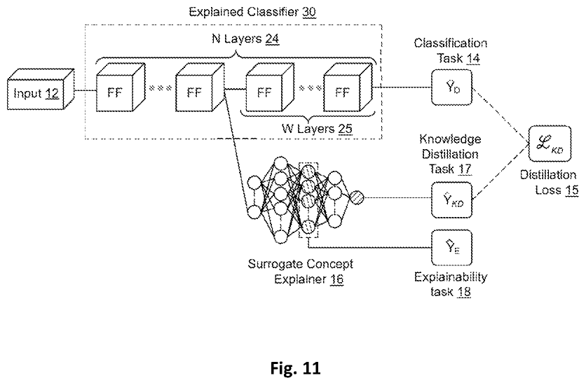

FIG. 9 shows a hierarchical multi-task machine learning model with an attention layer and a classification ML model score as an input according to an embodiment. This figure shows an example of a surrogate concept explainer that includes C layers 22, M layer 23, and attention layers 20. Each of the components are like their counterparts in FIG. 2 unless otherwise described. 12 represents an input, 13 represents an explained black-box, 14 represents a classification task, 15 represents a distillation loss, 17 represents a knowledge distillation task, 18 represents an explainability task, 20 represents attention layers, 21 represents attention weights, 22 represents common layers, and 23 represents concept layers. This figure comprises several embodiments, of the proposed approach, for feeding a classification machine learning model score to the surrogate model.

In an embodiment, the classification machine learning model score, S_{A}, inputs directly to the Attention Layers 20, together with input Z. This allows the Attention Layers 20 to learn the weights conditioned on a classification machine learning model score, e.g., what is the most relevant concept given a black-box model score is higher than a threshold. By way of non-limiting example, a threshold score is 0.69.

In an embodiment, the classification machine learning model score, S_{B1}, inputs the common Layers 22, or directly for each of the M Concept Layers 23, denoted by S_{B2}. This allows the concepts' layers to be conditioned on the fraud, specializing its knowledge given the classification machine learning model score.

In an embodiment, the classification machine learning model score, S_{A}, inputs directly to the Attention Layers 20, together with an input the common Layers 22, S_{B1}, or directly for each of the M Concept Layers 23, S_{B2}.

Because a goal of the surrogate model is to both approximate the classification machine learning model score, e.g., a black-box model score, while learning the concepts present in the inputs, it is possible to additionally include the classification machine learning model score as the input for the surrogate model.

The explainability task can be improved by knowing beforehand the likelihood of the input belonging to a given class. This information can be obtained using the classification machine learning model. Thus, this approach can improve the performance of the distillation task.

A leakage effect where the surrogate model learns to approximate the classification score using the classification score itself is possible. However, this is not necessarily problematic because the surrogate model has explainability as its main task which includes predicting the concepts while doing distillation. One possibility is that such an approach results in a trade-off that would overly benefit the distillation task while hindering the explainability task. To circumvent this while still improving the distillation task, in an embodiment, the classification machine learning model score is fed solely to the Attention Layers. In this approach, the score from the classification machine learning model helps to compute better dynamic attention weights to combine the prediction scores of the different concepts.

FIG. 10 shows a schematic representation of an embodiment of a multi-task machine learning model in which a main task is predicted first and its decision is input to the explainability task according to an embodiment. This configuration may provide more flexibility where 12 represents an input, 13 represents an explained black-box, 14 represents a classification task, 15 represents a distillation loss, 17 represents a knowledge distillation task, 18 represents an explainability task, 22 represents common layers, and 23 represents concept layers.

This architecture, dubbed here on as ReversedHMT, is composed of C+1+M layers, C of which, parameterized by θ_{C}, being common to both tasks, 1 of which, parameterized by θ_{KD}, responsible for the knowledge distillation task, and finally, M of which, parameterized by {\hat{θ}_{M}⁽ⁱ⁾}ᵢ₌₁^{K̅}, represent concept-specialized layers.

This architecture is hierarchical as the tasks are still sequential, but in this case the main classification task is predicted first, and its output is used on the explainability one. The output of this architecture is then a (k+1)-dimensional output vector of k explanations plus the predicted knowledge distillation score defined as f_{(x))=ŷ}_{E},ŷ_{K D}). The knowledge distillation output ŷ_{K D} is defined as ŷ_{K D}=h(h(x, θ_{C}), θ_{K D}), while the explainability task output is the common architecture with the main task decision score concatenated, defined as ŷ_{E}⁽ⁱ⁾=h((h(x, θ_{C}), θ_{K D}), θ_{M}⁽ⁱ⁾) where i represents the i-th concept.

ŷ_{E}⁽ⁱ⁾=h((h(x,θ_{C}),θ_{K D}),θ_{M}⁽ⁱ⁾)

The disclosed techniques may also be applied to explain other types of algorithms such as deep learning algorithms.

For example, let the binary classifier being explained c: [symbol] → [symbol] _{P} be a deep learning model with N layers 24, one can modify the disclosed explainer to only distil the last W layers 25 of the explained classifier 30 model, and therefore, achieve a higher explanation fidelity, as the explainer will focus on distilling the classifier's last layers responsible for obtaining a prediction. The explainer is defined as f:\hat{Z}→ [symbol] _{E}× [symbol] _{K D}, where Z=h( [symbol] , θ_{N-W}) is the neuron activation output space of the first N−W layers of the explained classifier C. The output of the explainer is then a (k+1)-dimensional output vector f(ĥ(x, θ_{N-W}))=(ŷ_{E}, ŷ_{K D}) of k explanations plus the predicted knowledge distillation score.

One difference between this neural network-specific embodiment and other disclosed embodiments is that the explainer receives as input an embedding produced at the N−W layer, instead of the raw input. This change allows for the explanation to be more aligned with the explained model as the explainer extracts the domain concepts from an embedding used by the classifier, instead of learning how to extract concepts from the raw input.

FIG. 11 shows an embodiment of neural network-specific surrogate explainer. This figure shows an example of an explainer that includes C layers 22, M layer 23, and attention layers 20. Each of the components are like their counterparts in FIG. 2 unless otherwise described. 12 represents an input, 14 represents a classification task, 15 represents a distillation loss, 16 represents a surrogate concept explainer, 17 represents a knowledge distillation task, 18 represents an explainability task, 24 represent a deep learning model with N layers, 25 represents the last W layers the explained classifier model, and 30 represents an explained classifier.

The models described herein may be trained in a variety of ways. In various embodiments, both the main task and the explainability task are learned jointly at the same time. In various embodiments, a sequential learning strategy is used, where a first task is learnt alone, and only after the first task I complete is the second task added to the training. When the second task is added, the pre-trained parameters can either continue to train or be frozen.

Considering the architectures where the explainability task comes first, (all of described architectures except ReversedHMT), the sequential learning strategy is equivalent to training an only-concepts network, where the training loss function is defined only as the explainability task loss, [symbol] = [symbol] _{E}.

In various embodiments, after the first step of training has finished, there are two options: (1) freeze the previously learnt parameters, only learning the parameters regarding the knowledge distillation task only, or (2) continue learning the whole network jointly. In the first case, because the previously learnt weights are not going to be trained, the architecture loss function is defined as just the knowledge distillation task, [symbol] = [symbol] _{KD}. In the second case, the training is analogous to the standard join training, where all parameters are updated, [symbol] =λ [symbol] _{KD}+(1−λ) [symbol] _{E}. Regarding the ReversedHMT architecture, the same learning strategies stand, but the tasks are reversed, meaning, that the first task to be learnt is the knowledge distillation one [symbol] _{KD}, and the second task is the explainability one [symbol] _{E}.

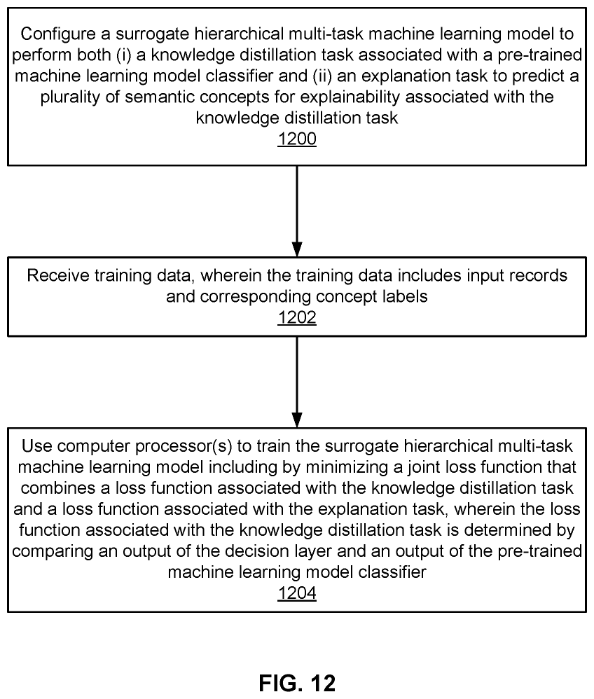

FIG. 12 is a flowchart illustrating an embodiment of a process for providing a surrogate hierarchical machine-learning model to provide concept explanations for a machine-learning classifier. The process may be implemented by the systems disclosed herein such as those shown in FIGS. 1-11.

In the example shown, the process begins by configuring a surrogate hierarchical multi-task machine learning model to perform both (i) a knowledge distillation task associated with a pre-trained machine learning model classifier and (ii) an explanation task to predict a plurality of semantic concepts for explainability associated with the knowledge distillation task (1200).

The pre-trained machine learning model classifier is sometimes called a black-box classifier or black-box model. An example is explained black-box 13. The black-box classifier determines a class estimate for a classification task.

The surrogate hierarchical multi-task machine learning model includes a concept layer to perform the explanation task and a decision layer to perform the knowledge distillation task. The output of the concept layer is utilized as an input to the decision layer. In various embodiments, black-box classifier estimates are utilized as input to the concept layer and the decision layer (e.g., the attention layer). In various embodiments, the concept layer receives input records and determines estimates for each concept class. The decision layer receives the estimates made by the concept layer and determines an estimate for the black-box classifier class estimates.

As further described herein, the decision layer can be implemented with an attention layer, among other things. The inputs for the attention layer can be the input records or the concept layer estimates. In various embodiments, black-box classifier estimates are utilized as input to the concept layer and/or the attention layer.

The process receives training data, where the training data includes input records and corresponding concept labels (1202). The concept labels may be extracted by a concept extractor, for example through weak supervision, manual annotation, teachers, etc.

The process uses one or more computer processors to train the surrogate hierarchical multi-task machine learning model including by minimizing a joint loss function that combines a loss function associated with the knowledge distillation task and a loss function associated with the explanation task (1204). The loss function associated with the knowledge distillation task is determined by comparing an output of the decision layer (e.g., a class estimate) and an output of the pre-trained machine learning model classifier. The joint loss measures the closeness of the prediction made by the surrogate model and the prediction made by the black-box classifier.

The disclosed techniques use a concept-based knowledge distillation method that can be applied to any ML model, including black-box models. Along with the knowledge distillation task, it is defined an explainability task that allows a surrogate model to produce high-level concept explanations. This surrogate model is framed as a hierarchical multi-task model that predicts concepts, domain knowledge explanations, and the ML model original task's output at the same time. Furthermore, it is also proposed a more specialized approach to explain neural networks that uses an intermediate embedding from the original model as the input for surrogate, instead of raw input vector.

The term “comprising” whenever used in this document is intended to indicate the presence of stated features, integers, steps, components, but not to preclude the presence or addition of one or more other features, integers, steps, components, or groups thereof.

The disclosure should not be seen in any way restricted to the embodiments described and a person with ordinary skill in the art will foresee many possibilities to modifications thereof. The above-described embodiments are combinable.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
configuring a surrogate hierarchical multi-task machine learning model to perform both (i) a knowledge distillation task associated with a pre-trained machine learning model classifier and (ii) an explanation task to predict a plurality of semantic concepts for explainability associated with the knowledge distillation task, wherein the surrogate hierarchical multi-task machine learning model includes:
a concept layer to perform the explanation task;
a decision layer to perform the knowledge distillation task, wherein the output of the concept layer is utilized as an input to the decision layer;
receiving training data, wherein the training data includes input records and corresponding concept labels; and
using one or more computer processors to train the surrogate hierarchical multi-task machine learning model including by minimizing a joint loss function that combines a loss is function associated with the knowledge distillation task and a loss function associated with the explanation task, wherein the loss function associated with the knowledge distillation task is determined by comparing an output of the decision layer and an output of the pre-trained machine learning model classifier.

2. The method of claim 1, wherein the output of the pre-trained machine learning model classifier is utilized as an input to at least one layer of the concept layer.

3. The method of claim 1, further comprising pre-training the concept layer.

4. The method of claim 1, wherein the surrogate hierarchical multi-task machine learning model includes an attention layer and an input to the attention layer includes at least one of:
the input records;
the output of the concept layer; or
the output of the pre-trained machine learning model classifier.

5. The method of claim 1, wherein:
the concept layer includes a common layer to receive input records; and
the common layer is coupled to at least one of: the decision layer or another layer of the concept layer.

6. The method of claim 5, wherein the output of the pre-trained machine learning model classifier is utilized as an input to the common layer.

7. The method of claim 5, further comprising pre-training the common layer.

8. The method of claim 5, wherein the surrogate hierarchical multi-task machine learning model includes an attention layer and an input to the attention layer includes at least one of:
the input records;
the output of the common layer;
the output of at least one layer of the concept layer; or
the output of the pre-trained machine learning model classifier.

9. The method of claim 5, wherein the surrogate hierarchical multi-task machine learning model includes an attention layer and an input to the attention layer includes the input records.

10. The method of claim 5, wherein the surrogate hierarchical multi-task machine learning model includes an attention layer and an input to the attention layer includes the output of the common layer.

11. The method of claim 5, wherein the surrogate hierarchical multi-task machine learning model includes an attention layer and an input to the attention layer includes the output of the pre-trained machine learning model classifier.

12. The method of claim 1, wherein using the one or more computer processors to train the surrogate hierarchical multi-task machine learning model includes backpropagating a calculated gradient of the joint loss function to update weights of the surrogate hierarchical multi-task machine learning model.

13. The method of claim 12, wherein backpropagating of the calculated gradient of the joint loss function to update the weights of the surrogate hierarchical multi-task machine learning model is interrupted between the decision layer and a concept classifier.

14. The method of claim 13, wherein the concept classifier is configured to receive class labels.

15. The method of claim 1, wherein the concept labels are obtained using a concept extractor.

16. The method of claim 1, wherein the surrogate hierarchical multi-task machine learning model and the machine learning model classifier are executed in parallel.

17. The method of claim 1, wherein the surrogate hierarchical multi-task machine learning model and the machine learning model classifier are trained substantially simultaneously.

18. The method of claim 1, wherein the loss function associated with the knowledge distillation task is determined by calculating a binary cross entropy between the output of the pre-trained machine learning model classifier and the output of the decision layer of the surrogate hierarchical multi-task machine learning model.

19. A system, comprising:
a processor adapted to:
configure a surrogate hierarchical multi-task machine learning model to perform both (i) a knowledge distillation task associated with a pre-trained machine learning model classifier and (ii) an explanation task to predict a plurality of semantic concepts for is explainability associated with the knowledge distillation task, wherein the surrogate hierarchical multi-task machine learning model includes:
a concept layer to perform the explanation task;
a decision layer to perform the knowledge distillation task, wherein the output of the concept layer is utilized as an input to the decision layer;
receive training data, wherein the training data includes input records and corresponding concept labels; and
use one or more computer processors to train the surrogate hierarchical multi-task machine learning model including by minimizing a joint loss function that combines a loss function associated with the knowledge distillation task and a loss function associated with the explanation task, wherein the loss function associated with the knowledge distillation task is determined by comparing an output of the decision layer and an output of the pre-trained machine learning model classifier; and
a memory coupled to the processor and configured to provide the processor with instructions.

20. A method, comprising:
configuring a machine learning model to perform both a decision task to predict a decision result and an explanation task to predict a plurality of semantic concepts for explainability associated with the decision task, wherein the machine learning model is configured as a multi-task hierarchical model including:
a semantic layer associated with the explanation task; and
a decision layer associated with the decision task, wherein the semantic layer and the decision layer are chained sequentially to provide an output of the semantic layer as an input to the decision layer;
receiving training data; and
using one or more hardware processors to train the multi-task hierarchical machine learning model using the received training data.
